(19) United States
(12) Patent Application Publication
(10) Pub. No.: US 2009/0327355 A1
(43) Pub. Date: Dec. 31, 2009

(54) SYSTEM AND METHOD FOR COORDINATING A POINT-IN-TIME COPY AMONG MULTIPLE DATA PROVIDERS

(75) Inventors: Brian L. Wong, Midlothian, VA (US); David Robinson, Seattle, WA (US); Spencer Shepler, Austin, TX (US); Richard J. McDougall, Menlo Park, CA (US)

Correspondence Address: PVF -- SUN MICROSYSTEMS INC.;C/O PARK, VAUGHAN & FLEMING LLP, 2820 FIFTH STREET, DAVIS, CA, 95618-7759, US

(73) Assignee: Sun Microsystems, Inc., Santa Clara, CA (US)

(21) Appl. No.: 12/165,545

(22) Filed: Jun. 30, 2008

(51) Int. Cl. G06F 17/30

(52) U.S. Cl. 707/201; 707/E17.005

(57) ABSTRACT

A system and method for coordinating a point-in-time copy (PITC) of a file or set of data distributed (e.g., striped) across multiple data providers (e.g., filers, file servers, storage arrays). A service coordinator receives a PITC request for a parent file, initializes the PITC's metadata and instructs the data providers to generate PITC subcomponents for the portions (e.g., sub-mirrors) of the file that they store. A scoreboard is created to track the status of the PITC, and includes an entry for each PITC subcomponent. Quality of service characteristics for the PITC may be copied from the parent and/or received with the request. If those characteristics cannot be attained, the PITC may be aborted. As PITC subcomponents are completed, they are returned to the service coordinator for assembly of the PITC.

### RELATED APPLICATION

This application is related to U.S. patent application Ser. No. 10/831,096 (Attorney Docket SUN04-0576), entitled “System and Method for Facilitating a Consistent Point-In-Time Copy” and filed Apr. 23, 2004, which is incorporated herein by reference.

### BACKGROUND

This invention relates to the field of computer systems. More particularly, a system and method are provided for coordinating a point-in-time copy of a set of electronic files or other data distributed among multiple data providers or sources.

The advent of point-in-time copy functions has given filers, data servers and other entities that manage stored data the ability to take snapshot copies of their data as of a specified time. During a point-in-time copy, a dataset is momentarily frozen (i.e., to prevent updates) and the locations of data in the dataset are captured. After the point-in-time copy is made, the dataset is thawed and made live again, while the point-in-time copy can be used as desired (e.g., to make a backup of the dataset).

More particularly, a point-in-time copy of a file stored entirely on a single disk drive or disk array involves preserving those contents via pointer replacement. A new pointer is generated to identify the beginning of the file, but no additional storage is allocated to the point-in-time copy unless and until the file is modified (e.g., written to). When a data block is modified, its contents are copied to a new block. Therefore, after the point-in-time copy, the original file contents are preserved and are accessible via one chain of pointers, while the live version of the file is accessible via another chain.

In some computing environments, existing communication protocols do not allow for coordination of a point-in-time copy between the storage node or entity performing the copy (e.g., a disk array, a server) and the devices currently accessing the dataset (e.g., client computers, other servers). In such environments, it is highly probable that the point-in-time copy will be inconsistent—that it will not capture the true state of the dataset because one or more of the other devices will have data that should be included in the copy.

U.S. patent application Ser. No. 10/831,096 provides a system and method for facilitating a consistent point-in-time copy of a specified dataset stored on a single disk drive, storage array, file server or other entity, so that the point-in-time copy will accurately reflect the state of the dataset at the time of the copy.

When a set of files is distributed across multiple filers or file servers, however, no one filer acting alone can easily ensure a consistent point-in-time copy is made of that fileset. Each filer stores only a portion of the data to be copied, and may not be able to easily determine the status or consistency of other portions.

Thus, what is needed is a system and a method for facilitating or coordinating a consistent point-in-time copy of a set of files distributed among multiple filers, so that the point-in-time copy will accurately reflect the state of the fileset at the time of the copy.

### SUMMARY

In one embodiment of the invention, a system and method are provided for coordinating a point-in-time copy (PITC) of a file or set of data distributed (e.g., striped, mirrored) across multiple data providers (e.g., filers, file servers, storage arrays).

A service coordinator receives a PITC request for a parent file or set of files, initializes the PITC's metadata (e.g., from the parent's metadata) and instructs the data providers to generate PITC subcomponents for the portions (e.g., sub-mirrors) of the file that they store. Quality of service characteristics for the PITC may be copied from the parent and/or received with the PITC request. If those characteristics cannot be attained, the PITC may be aborted.

Unavailable or inconsistent portions may not be copied, which may cause the PITC to be aborted if a valid PITC cannot then be assembled. As the PITC subcomponents are completed, they are returned to the service coordinator for assembly of the PITC.

In this embodiment, a scoreboard is created to track the status of the PITC, and includes an entry for each PITC subcomponent. The scoreboard may be stored in the PITC's metadata, on the service coordinator or in some other location accessible to the service coordinator and the data providers. The service coordinator may be a centralized or distributed service for coordinating PITCs of distributed files and/or providing other services (e.g., nameserver services, data, metadata).

### DESCRIPTION OF THE FIGURES

FIG. 1 is a block diagram depicting a computing environment in which an embodiment of the present invention may be implemented.

FIG. 2 is a flowchart illustrating one method of coordinating a point-in-time copy of a set of files distributed across multiple filers, in accordance with an embodiment of the invention.

### DETAILED DESCRIPTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

In one embodiment of the invention, a system and a method are provided for coordinating a point-in-time copy (PITC) of a set of files stored or distributed across multiple filers (or other entities) that share data via NFS (Network File System) or another suitable protocol. Because target files or portions of the target files are stored on different filers, no one filer acting along can easily ensure the consistency and completeness of the target fileset for purposes of the PITC.

In one implementation of this embodiment, the PITC requires client devices to flush fileset contents they are working on. Methods of performing this phase of the PITC are described in U.S. patent application Ser. No. 10/831,096. After the clients flush their data, the filers that host portions of the target fileset perform point-in-time copies of their portions. The resulting subcomponents of the fileset PITC can then be aggregated, added to a namespace, etc.

The entity requesting a PITC of a fileset may specify completion and/or success criteria, for use in determining whether and how to proceed in the event of an error. For example, a PITC may be aborted if not all participating filers successfully copy their portions within a given period of time, if a threshold number of errors is accumulated while the PITC is pending, if a desired quality of service of the PITC cannot be attained, or for other reasons.

In embodiments of the invention described herein, any or all of the PITC operations may be performed using two-phase commitment. In particular, an intended operation may first be noted or recorded before actually being performed, so that if an error occurs before the operation is completed (e.g., a participating filer fails), the system can easily recover or rollback.

In different embodiments of the invention, a PITC of a set of files distributed across multiple filers may be coordinated by one of the filers, a centralized service coordinator (which may or may not coexist with a filer), a client or some other entity. The manner in which a completed PITC is made available (e.g., added to a network namespace) may depend upon the computing environment.

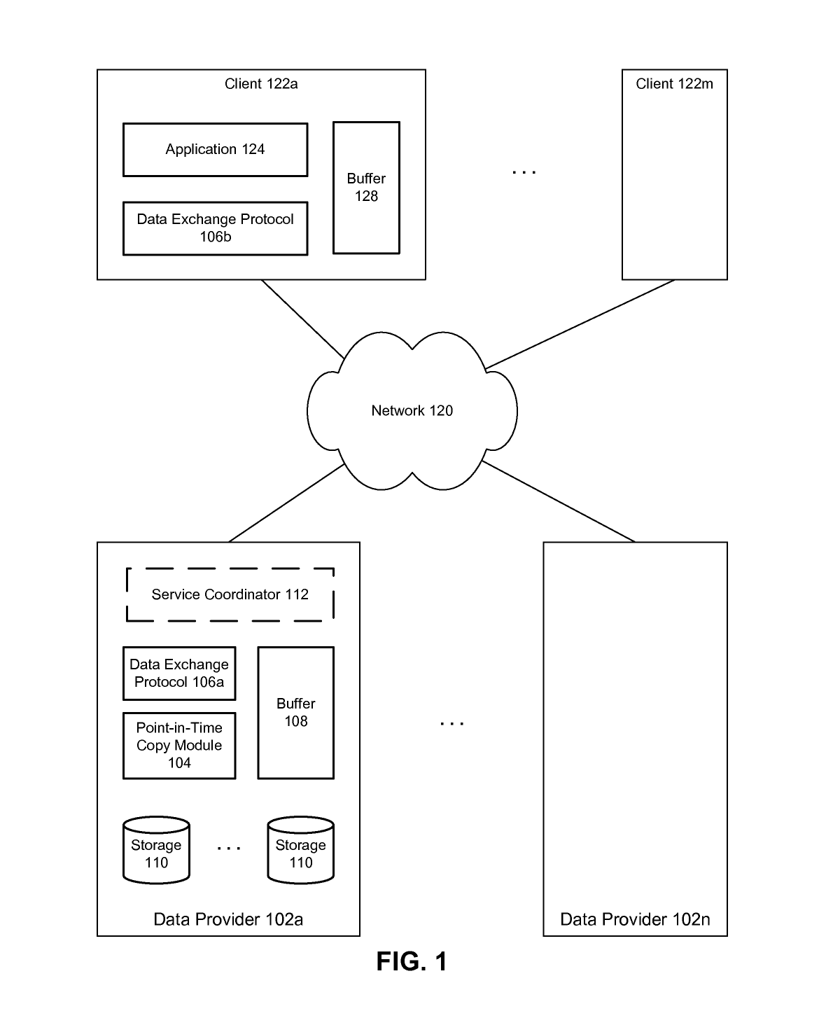

FIG. 1 is a block diagram of a computing environment in which an illustrative embodiment of the invention may be implemented. In this environment, client computing devices (e.g., NFS clients) such as clients 122a-122m are coupled to data providers (e.g., NFS servers), such as providers 102a-102n, by network 120, which may comprise the Internet, an organization's intranet or some other network. In other embodiments, clients and/or data providers may be coupled via other types of communication connections, which may be dedicated or shared, wired or wireless.

In the environment of FIG. 1, data providers 102a-102n are NAS (Network Attached Storage) servers or other entities (e.g., storage arrays, disk controllers) configured to provide data to clients. Each data provider includes any number of storage devices (e.g., disk drives) 110, which may be operated as a RAID (Redundant Array of Independent Devices), another type of storage array, or as independent devices.

Clients 122a-122m may include workstations, laptops, desktops, hand-held devices, other data consumers, or some other computing devices configured to execute application 124, which manipulates or accesses data stored on one or more data providers.

Data providers 102 include point-in-time copy (PITC) module 104 for making point-in-time copies of all or any portion of the contents of storage devices 110. As described below, PITC module 104 may be configured to cooperate with other data providers to perform PITCs of files or filesets distributed across those providers.

For example, a file may be striped across multiple data providers' storage devices. In addition, some or all stripe members' data may be mirrored. In order to produce a consistent PITC of such a file, consistent copies of the file portions stored on each stripe member must be assembled and PITC subcomponents made of each portion. However, failure to complete a PITC subcomponent of a mirror member need not prevent the PITC from completing (e.g., it may not be essential, or may be recoverable from another mirror member), but failure of a PITC subcomponent of a stripe member may require failure or rollback of the PITC.

Data providers 102 also operate provider version 106a of data exchange protocol 106 for exchanging files with clients. Data exchange protocol 106 may handle data at any granularity (e.g., bytes, blocks, files), and therefore may comprise a protocol such as SCSI (Small Computer System Interface), ATA (Advanced Technology Attachment), NFS (Network File System), CIFS (Common Internet File System or Common Internet File Services), etc.

In the illustrated embodiment of the invention, each data provider also includes a buffer 108 (e.g., a write-aside buffer) for temporary storage of data. As described below, buffer 108 may be used to temporarily store updates to a dataset while a PITC of that dataset is pending or in process. This may allow file operations to be queued during the PITC, instead of being rejected or stalled.

Similarly, each client 122 includes a buffer 128 and operates client version 106b of data exchange protocol 106. In addition to the protocols identified above, other file sharing protocols that may be implemented in this embodiment of the invention include IPX (Internetwork Packet exchange) by Novell, Inc., AFP (Apple File Protocol) by Apple Computer, Inc., and so on.

A data provider may include a service coordination module, such as service coordinator 112 of data provider 102a. Alternatively, a service coordinator may operate on a client or some other computer system not configured to act as a client or a data provider, such as a dedicated service coordination server.

In one embodiment of the invention, a service coordinator is configured to coordinate or direct execution of a PITC of a file or fileset distributed (e.g., striped) across multiple data providers. The service coordinator thus instructs each cooperating data provider to make a copy of its portion of the file and to report completion, failure and/or errors or other statuses. The service coordinator is therefore responsible for determining whether the PITC operation was successful, and may be responsible for making the PITC available (e.g., for backup or other purposes).

If a data provider cannot copy its portion of the file, the PITC may be aborted or allowed to continue. If it continues, the final PITC may be marked to indicate that it is inconsistent.

In one alternative embodiment of the invention, a service coordinator may also be configured to provide a nameserver service to data providers, and/or store shared files and/or their metadata. Further, a service coordinator's functions may be distributed across a network or among multiple data providers.

In other embodiments of the invention, data providers and clients may be configured differently from the embodiment of FIG. 1. Such other embodiments are similar to the illustrated embodiment in that the data providers are capable of performing point-in-time copies, and the data providers and clients exchange data via a data sharing protocol (not necessarily a file sharing protocol) that can be adapted as described herein to promote data consistency for the PITC and facilitate cooperation between the data providers.

As described above, a PITC of a file or fileset distributed among multiple data providers, which may be termed a “multi-component PITC”, may be initiated or requested by various entities (e.g., a client, a data provider, a service coordinator). However, a client may be prohibited from actually executing or coordinating a multi-component PITC of data that the client does not own or have sufficient privileges to access. Or, a client may be prevented from coordinating multi-component PITCs for other reasons, such as communication latencies between the client and data providers, a network partition between the client and a data provider, etc.

A client that issues a request for a multi-component PITC to a data provider or service coordinator is considered the issuing client for the operation. A PITC request may identify a specific set of data to be copied (e.g., one or more files), a consistency point, how to handle a communication failure, etc.

A consistency point indicates when the selected set of data should be made consistent. The consistency point may be specified as a date, a time, an event, a client state or status, or anything else that can be mutually understood by cooperating data providers and/or clients. Embodiments of the invention described herein may employ dates or times as consistency points, but these embodiments do not limit the scope of the invention. If no specific consistency point is identified or requested, a default consistency point may be selected (e.g., the date or time at which the PITC is requested or initiated).

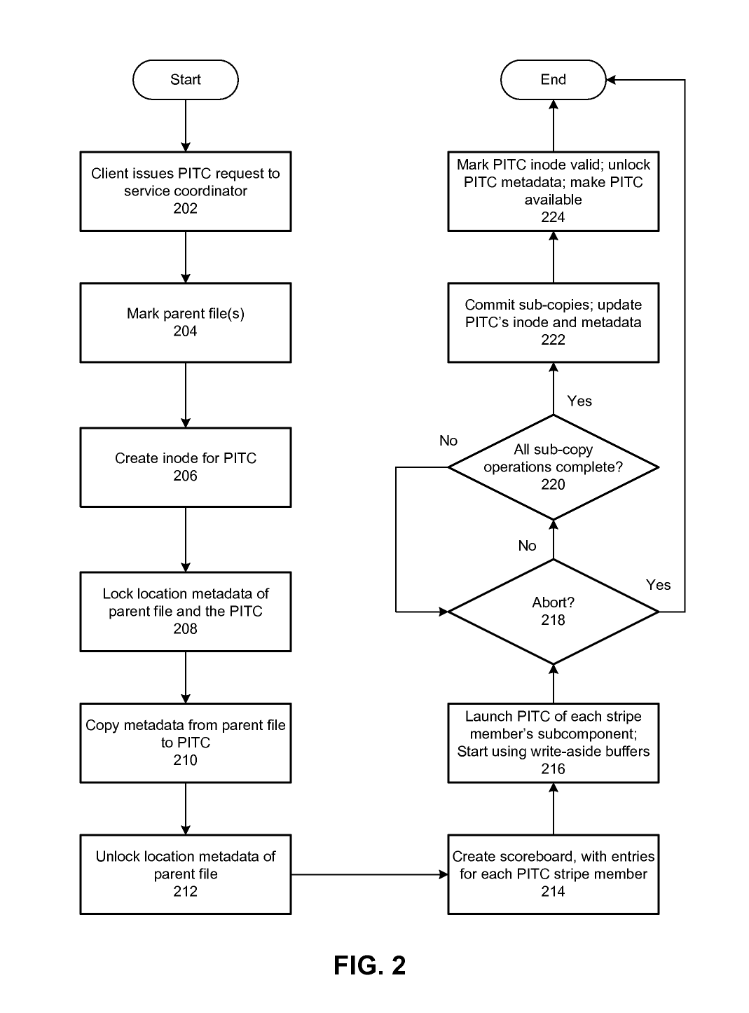

FIG. 2 demonstrates a method of coordinating a multi-component PITC according to one embodiment of the invention. In this embodiment, the PITC is requested by a client, but is coordinated or executed by a service coordinator. The service coordinator may or may not coexist with a data provider.

In operation 202, the client issues a request for a PITC of one or more files to the service coordinator. Or, the client may issue the request to a data provider, which then relays the request to the service coordinator. Different service coordinators may be responsible for coordinating PITCs of different files or filesets. In this embodiment of the invention, the PITC request identifies a specific consistency point, or the consistency point may be inferred to be the date/time of the request.

Each file to be point-in-time copied is striped and/or mirrored across multiple member data providers (e.g., filers, file servers, storage arrays). If the multi-component PITC request identifies multiple files to be copied (e.g., a directory or other fileset), the remainder of the method of FIG. 2 may be performed in parallel for the multiple files, or each file may be point-in-time copied in sequence.

In the illustrated embodiment of the invention, only one PITC operation may be pending at a time for a given file. In other embodiments, multiple PITC operations for one file may be pending simultaneously.

In operation 204, the service coordinator marks the file to be copied (the “parent”). This may involve setting a “PITC pending” flag. Also, each member data provider (e.g., members of the parent's stripe set) may be notified by the service coordinator of the PITC request.

In operation 206, a new inode is created for the PITC. For non-Unix-based operating systems, this may involve the creation of a new directory entry or file structure. It may be noted, in the inode or the PITC's metadata, that the PITC is a copy of the parent.

Ownership of the PITC may be set identically to ownership of the parent. Or, the service coordinator or other entity (e.g., the issuing client) may be named as owner. Illustratively, the PITC will be stored in the same manner as the parent (e.g., striped across the member data providers). However, storage space need not be allocated for the PITC until after the PITC operation is complete, the copied file is again live, and the file's contents change. At that time, the PITC and the live version of the file may diverge.

More specifically, and as described below, copy-on-write operations may be performed as each block of the file is modified for the first time after the PITC. Thus, the PITC initially may be simply a new pointer to the parent file, and then slowly grow to replicate the file as it existed at the time of the consistency point.

In operation 208, some or all of the metadata of the parent is locked, particularly the location metadata. This may be done to prevent its layout from being altered (e.g., to create a new sub-mirror) while the PITC is being initialized.

In operation 210, some or all of the parent's metadata, except the location metadata, is copied to the PITC. Of special interest may be the parent's quality of service (QoS) characteristics or parameters, which may be used as described below to determine whether to abort or proceed with the PITC. For example, if the operating policies regarding the parent specify that at least X copies (e.g., sub-mirrors) of a subcomponent of the parent must be available, and some number of consistent copies less than X is obtained during the PITC operation, the operation may be aborted or rescheduled.

In operation 212, the location metadata of the parent is unlocked. This may result in the PITC having a creation date that is out-of-synch with (i.e., later than) the parent. Although the data being point-in-time copied would technically be copied later than the creation date, consistency would be maintained. Illustratively, the PITC's creation date could be adjusted (after completion of the multi-component PITC) to match the date the parent's location metadata is locked or unlocked.

In one alternative embodiment of the invention, the parent's location metadata is not unlocked until the PITC is complete (or aborted). In this alternative embodiment, the PITC's creation date will be synchronized with the parent.

In operation 214, a scoreboard is created for the PITC. Illustratively, the scoreboard may be created within the PITC's metadata, on the service coordinator or in some other location.

In this embodiment of the invention, the scoreboard's purpose is to centrally and consistently record the status of PITC subcomponents (i.e., the copies of each member data provider's sub-mirrors). Therefore, the scoreboard contains entries for every sub-mirror of every subcomponent of the parent. Updates to the scoreboard may be transacted, may be performed synchronously or may be carried out in some other safe manner.

If organization of the member data providers is not regular, the parent may be sparse. For example, if the parent is in the process of being converted from a RAID-0 (striping) format to a RAID-0+1 (mirrored striping) format, some subcomponents may not yet be mirrored.

In operation 216, each member data provider launches (e.g., under the direction of the service coordinator) a PITC on each sub-mirror of subcomponents of the parent stored on the member. In the scoreboard, each member's subcomponent is marked as “pending.”

U.S. patent application Ser. No. 10/831,096, which is incorporated herein, describes one method for facilitating a consistent point-in-time copy of data stored on a single data provider. For example, the data provider may instruct all clients currently accessing that data to flush any updates so that the data provider can ensure it has a consistent view of the data.

Also in operation 216, member data providers may use buffers (e.g., write-aside buffers) to capture updates to the parent that are generated or received while the PITC is pending. In particular, because the PITC may take a measurable amount of time (e.g., depending on the number of member data providers and subcomponents), if write operations are allowed to continue they must be deferred in order to preserve the consistency of the PITC.

In one implementation, after the specified consistency point, updates from clients are stored in the buffer until the PITC is complete. In this example, a data provider's buffer is used to maintain the current, real-time, status of the member's subcomponent, while the actual subcomponent will contain the status as of the consistency point. Read operations may be conducted against the buffer. If write operations are not permitted during the PITC, then write-aside buffers may be omitted.

The PITC subcomponent operations may be initiated asynchronously. In some cases, a copy operation may not be performed on a particular subcomponent or sub-mirror, such as when a sub-mirror is currently “inconsistent” or “incomplete.” Each member data provider's resulting copy of its subcomponent of the PITC is returned to the service coordinator. Either the member or the service coordinator may update the scoreboard for each sub-PITC (e.g., to “completed-pending”).

In operation 218, the service coordinator may determine whether the PITC should be aborted. For example, if so many errors accumulate that a QoS characteristic of the parent cannot be satisfied, the operation may be aborted. Thus, if one of the parent's QoS characteristics specifies that at least 2 independent copies or sub-mirrors of a subcomponent are required, but only one sub-mirror can be copied, the whole PITC may be aborted.

In one embodiment, a PITC operation may apply QoS parameters or characteristics that override conflicting parameters of the parent. Illustratively, overriding parameters may be specified in the multi-component PITC request. Also, a PITC request may have a specified timeout period, after which the service coordinator may abort the PITC or determine whether the PITC should be aborted.

If a PITC of a subcomponent fails or no response is received from the corresponding data provider, the associated scoreboard entry may be marked to reflect an error.

If not aborted in operation 218, in operation 220 the service coordinator determines whether all PITC subcomponent operations have completed. Until the scoreboard indicates that all subcomponents are available (e.g., “completed-pending”), or until a timeout period expires, the method may loop between operations 220 and 218.

If the multi-component PITC is not aborted, and all PITC subcomponents are completed and consistent, in operation 222 the subcomponents are committed. Illustratively, if some subset of the members' subcomponents cannot be committed, the entire operation may be rolled back or the commitment process may be extended to give the offending member(s) more time.

Also in operation 222, assuming all subcomponents are committed, the service coordinator assembles the subcomponent information into a valid set of location metadata. The PITC's inode, location metadata and other relevant metadata (e.g., creation date) are then set.

In operation 224, the service coordinator marks the PITC's inode as valid and unlocks its metadata. The PITC-pending flag on the parent is cleared and/or the PITC request is dequeued if necessary (i.e., if there are multiple pending PITCs for the parent). The service coordinator may then acknowledge the multi-component PITC request to the issuing client (e.g., and provide a reference to the PITC). After the multi-component PITC is complete, pending updates (e.g., post-consistency updates placed in a data provider's write-aside buffer) can be rolled into the parent.

Operation 224 may also involve noting certain information within the multi-component PITC's metadata. For example, in an environment in which multiple generations of a file are maintained (e.g., for historical, archival or backup purposes), a PITC's metadata may identify its ancestry, indicate which generation it belongs to, etc.

The manner in which the PITC is made available may depend upon the computing environment in which the PITC was created. For example, in a POSIX environment, the name of the PITC is entered into the name service. This may not be necessary in a non-POSIX environment.

The program environment in which a present embodiment of the invention is executed illustratively incorporates a general-purpose computer or a special purpose device such as a hand-held computer. Details of such devices (e.g., processor, memory, data storage, display) may be omitted for the sake of clarity.

It should also be understood that the techniques of the present invention may be implemented using a variety of technologies. For example, the methods described herein may be implemented in software executing on a computer system, or implemented in hardware utilizing either a combination of microprocessors or other specially designed application specific integrated circuits, programmable logic devices, or various combinations thereof.

In particular, methods described herein may be implemented using data structures and program code residing on a suitable computer-readable medium, which may be any device or medium that can store data and/or code for use by a computer system. This includes, but is not limited to, volatile memory, non-volatile memory, magnetic and optical storage devices such as disk drives, magnetic tapes, CDs (compact discs), DVDs (digital versatile discs or digital video discs), or other media capable of storing computer-readable media now known or later developed.

The foregoing embodiments of the invention have been presented for purposes of illustration and description only. They are not intended to be exhaustive or to limit the invention to the forms disclosed. Accordingly, the scope of the invention is defined by the appended claims, not the preceding disclosure.

What is claimed is:

1. An automated method of facilitating a consistent point-in-time copy (PITC) of a file striped across multiple data providers, the method comprising:
receiving a request to perform a PITC of the file;
creating a scoreboard configured to indicate a status of the PITC, said scoreboard comprising an entry for each of the multiple data providers;
directing each of data provider to create a PITC subcomponent of a portion of the file stored on the data provider;
updating said scoreboard to indicate the status of each said sub-PITC; and
if each said PITC subcomponent is completed successfully, assembling said PITC subcomponents into the PITC.

2. The method of claim 1, further comprising:
if said PITC subcomponents are not completed within a threshold period of time, determining whether to abort the PITC.

3. The method of claim 1, further comprising, prior to said directing:
initializing a data structure for the PITC; and
copying metadata of the file, other than location metadata, to metadata of the PITC.

4. The method of claim 3, wherein said data structure is an inode.

5. The method of claim 3, wherein said copying comprises copying a set of quality of service parameters of the parent file.

6. The method of claim 1, wherein the request comprises a set of quality of service parameters for the PITC.

7. The method of claim 1, further comprising storing said scoreboard within metadata of the PITC.

8. The method of claim 1, wherein said updating comprises:
changing an entry for a PITC subcomponent to “pending” in conjunction with said directing; and
changing said entry to “completed-pending” upon completion of said sub-PITC.

9. The method of claim 1, further comprising:
receiving said PITC subcomponents from the multiple data providers.

10. The method of claim 1, wherein said receiving, said creating and said directing are performed by a service coordinator operating independently of the multiple data providers.

11. The method of claim 1, further comprising, on each of the multiple data providers:
initiating said PITC subcomponent, said initiating comprising:
requesting a set of clients to flush updates to the file that were pending as of a specified consistency point;
receiving from a first client in the set of clients a first notification that the flushing of pending updates has been completed; and
if notifications of completion of the flushing of pending updates are not received from each client in the set of clients within a threshold period of time, determining whether to abort the PITC subcomponent.

12. The method of claim 11, wherein the request to perform a PITC identifies the specified consistency point.

13. The method of claim 11, wherein said directing comprises identifying the specified consistency point.

14. The method of claim 11, wherein the specified consistency point is selected by the data provider.

15. The method of claim 11, further comprising:
deferring one or more updates to the dataset that were generated after said consistency point.

16. The method of claim 15, wherein said deferring comprises, at a client:
receiving an update to the file after the specified consistency point; and
storing said update until notification of completion of the flushing of pending updates is sent.

17. The method of claim 15, wherein said deferring comprises, at the data provider:
receiving an update to the file after said first notification from the first client is received; and
storing said update until the sub-PITC is performed.

18. A computer readable medium storing instructions that, when executed by a computer, cause the computer to perform a method of facilitating a consistent point-in-time copy (PITC) of a file striped across multiple data providers, the method comprising:
receiving a request to perform a PITC of the file;
creating a scoreboard configured to indicate a status of the PITC, said scoreboard comprising an entry for each of the multiple data providers;
directing each of the data provider to create a PITC subcomponent of a portion of the file stored on the data provider;
updating said scoreboard to indicate the status of each said sub-PITC; and
if each said PITC subcomponent is completed successfully, assembling said PITC subcomponents into the PITC.

19. A computer system configured to facilitate a consistent point-in-time copy (PITC) of a file striped across multiple data providers, comprising:
a data exchange protocol configured to:
receive a request to perform a PITC of the file; and
instruct the multiple data providers to create PITC subcomponents of portions of the file stored on the multiple data providers;
scoreboard logic configured to create a scoreboard for indicating statuses of said PITC subcomponents; and
logic configured to assemble said PITC from said PITC subcomponents.

20. The computer system of claim 19, wherein said logic is further configured to abort said PITC if a set of quality of service characteristics for said PITC cannot be satisfied.
